(19) United States
(12) Patent Application Publication
(10) Pub. No.: US 2004/0081110 A1
(43) Pub. Date: Apr. 29, 2004

(54) System and method for downloading data to a limited device

(75) Inventor: Oskari Koskimies, Helsinki (FI)

Correspondence Address: Crawford PLLC, Suite 390, 1270 Northland Drive, St. Paul, MN, 55120, US

(73) Assignee: Nokia Corporation

(21) Appl. No.: 10/282,510

(22) Filed: Oct. 29, 2002

(51) Int. Cl. H04B 7/14; H04J 1/00; H04J 3/08

(52) U.S. Cl. 370/315

(57) ABSTRACT

A system and method for downloading desired data to a target device. The target device initiates a connection with a mobile device storing data retrieval information, which is then communicated from the mobile device to the target device for use by the target device in retrieving desired data. A data call is established between the target device and a data storage system by way of the mobile device, where the data call is established using at least some of the data retrieval information. The desired data is transmitted from the data storage system to the target device via the data call established by way of the mobile device.

### FIELD OF THE INVENTION

This invention relates in general to wireless communications, and more particularly to a system and method for facilitating downloading digital content, configuration data, or other data to devices otherwise limited in their ability to control the downloading of such data.

### BACKGROUND OF THE INVENTION

Electronics, software, and digital content are currently used in an astonishingly wide range of consumer products. These products often include discrete logic components or processor chips, either of which may utilize digital content or operate under the control of software. Digital content, such as audio sounds, images, and video are provided with many consumer electronics products. For example, toys, alarm clocks, doorbells, and other products often come equipped with sounds or other content to enhance their usability or simply make for a better user experience. Modem day alarm clocks, for example, often include sounds such as ocean waves, rainfall, or other sound clips that can be played. Various alarm sounds and even songs can also be played on such alarm clocks. The same holds true for products such as electronic doorbells, where different doorbell chimes, songs, etc. can be selected. Another consumer product traditionally capable of presenting sounds or other content includes toys, such as children's cars and trucks, stuffed animals, games, and the like. The reach of digital content in today's digital world is virtually endless.

Products such as those described above are generally sold with one or more predetermined digital content items. For example, a child's toy truck may come from the manufacturer with two or three preset sounds that the truck can produce. However, notwithstanding the appeal of these sounds to users of these devices, the users may become tired of the limited set of content items available on their product. One way to address this problem is to update the content in the device with new content. Using traditional means, this does not come without a cost, both financially and in terms of the product's appearance or usability. For example, it is possible that a child's toy, such as a teddy bear capable of making sounds, can have its sounds updated by replacing a diskette with a new diskette having new sounds. A disk drive, however, would certainly affect the appearance, usability, and cost of the teddy bear. In a marketplace where production and retail costs may mean the difference between a successful and unsuccessful product, inclusion of such components is simply undesirable.

Another manner of updating content in consumer products is to utilize wireless technology capable of accessing mobile communications networks and possibly the Internet. Again, this would result in added cost and reduced appeal of the device, as the device would require a relatively complex user interface if content searching and retrieval via a cellular network is to be supported. For these and other reasons, these products are not generally equipped with such user interfaces, and content updating remains a difficult proposition.

A related problem associated with the downloading of content to consumer products is the problem of Digital Rights Management (DRM). In addition to ensuring that downloaded content cannot be pirated, it should also be possible to restrict the use of certain content to only certain devices. For example, the owners of a blockbuster movie may want to ensure that only toys based on that movie can play sounds associated with the movie. These issues add additional complexities that are typically not the type that designers or manufacturers of such consumer products want to involve themselves with, again for reasons related to unit development, production, and retail cost, as well as the ultimate appeal of the product.

Accordingly, there is a need in the communications industry for a manner of updating digital content, configuration data, or other software in devices otherwise limited in their capabilities to locate and download such data. The present invention provides a manner of updating such devices with new data, without providing any significant costs or reducing the appeal of the devices, and without limiting the availability of information that can be downloaded to the devices. The present invention fulfills these and other needs, and offers other advantages over the prior art.

### SUMMARY OF THE INVENTION

The present invention is directed to a system, and method for facilitating downloading digital content, configuration data, or other data to devices otherwise limited in their ability to control the downloading of such data.

In accordance with one embodiment of the invention, a method is provided for acquiring data retrieval information at a target device. The data retrieval information includes information that may be used by the target device in retrieving desired data. The target device initiates a connection between the target device and a mobile device storing the data retrieval information. The data retrieval information is communicated from the mobile device to the target device, wherein the data retrieval information is then available for use by the target device in retrieving the desired data.

In more particular embodiments of such a method, the target device and the mobile device can communicate in various manners, such as via an infrared connection, a Bluetooth connection, a Wireless Local Area Network (WLAN) connection, a cable, etc. In other particular embodiments, various ways of initiating a connection between the target and mobile devices may be used in connection with the present invention, such as by detecting communication availability of the mobile device by the target device, and by activating a user input mechanism on the target device by a user such as pressing a button, speaking a voice command, etc.

In another particular embodiment of such a method, a data call is established between the target device and the data storage system by way of the mobile device, where the data call is established using at least some of the data retrieval information, such as a telephone number used to reach the data storage system. The desired data is then transmitted from the data storage system to the target device via the data call established by way of the mobile device. In a more particular embodiment, the data is transmitted from the data storage system to the mobile device using a first wireless technology, such as a wireless technology used in cellular networks, and the data is transmitted from the mobile device to the target device using a different transmission technology, such as infrared, Bluetooth, wired connection, etc. In still more particular embodiments, Digital Rights Management (DRM) rules may be implemented, where the data is encrypted prior to transmitting the desired data from the data storage system, and/or a message(s) that includes the data retrieval information may be designated as a single-use ticket.

In another particular embodiment of such a method, the data retrieval information is communicated from the data storage system storing the desired data to the mobile device prior to communicating the data retrieval information from the mobile device to the target device. This may be accomplished, for example, by transmitting at least one wireless message, such as an SMS message, including the data retrieval information from the data storage system to the mobile device. In another specific embodiment, a request for the data retrieval information may be initiated from the mobile device to the data storage system via an SMS request message or other message, where the message from the data storage system is transmitted to the mobile device in response to the request message.

In accordance with another embodiment of the present invention, a method is provided for downloading desired data to a target device. The method includes downloading over-the-air (OTA) a data ordering program to an intermediary mobile device. The data ordering program is executed on the intermediary mobile device, which allows selection of the desired data to be downloaded from the data storage system to the target device. The selected data is then downloaded from the data storage system to the target device by way of the intermediary mobile device.

In more particular embodiments of such a method, downloading OTA a data ordering program includes downloading a Java midlet to a Java-compliant intermediary mobile device. In another particular embodiment, downloading OTA a data ordering program includes downloading the data ordering program to a Symbian OS-based intermediary mobile device. Any type of downloadable code operable on the intermediary mobile device may be used in connection with the present invention. In more particular embodiments, the data ordering program may first download the desired data to the intermediary mobile device and subsequently download the data to the target device, or the download between the intermediary mobile device and each of the data storage and target devices may take place substantially concurrently.

In accordance with another embodiment of the invention, a system for distributing digital data is provided. The system includes a data storage system to store available digital data, and a target device capable of communicating through a local connection. An intermediary wireless device is configured to communicate over-the-air (OTA) remotely with the data storage system, where the intermediary wireless device controls retrieval and/or order information for a digital data download(s) from the data storage system to the target device by way of the intermediary wireless device.

The above summary of the present invention is not intended to describe each illustrated embodiment or implementation of the present invention. This is the purpose of the figures and the associated discussion which follows.

### BRIEF DESCRIPTION OF THE DRAWINGS

The invention is described in connection with the embodiments illustrated in the following diagrams.

FIG. 1 is a block diagram illustrating a manner of downloading data to a limited device in accordance with one embodiment of the present invention;

FIG. 2 is a flow diagram of one embodiment of a method for downloading data to a target device in accordance with the present invention;

FIG. 3 is a block diagram illustrating a more particular example of the data downloading system and methodology of the present invention;

FIG. 4 illustrates a representative messaging sequence for downloading data to a limited device in accordance with one embodiment of the present invention;

FIG. 5 illustrates an example of an SMS reply message that may be used in connection with the invention;

FIGS. 6 and 7 are flow diagram illustrating alternative embodiments of a download procedure utilizing a Java midlet from the user's point of view;

FIGS. 8A-8H illustrate a representative series of mobile device user interface screens that may be presented via the mobile device during a Java midlet download procedure; and

FIG. 9 illustrates a representative messaging sequence for downloading data to a limited device and including content encryption and marking transactions.

### DETAILED DESCRIPTION OF THE INVENTION

In the following description of the exemplary embodiment, reference is made to the accompanying drawings which form a part hereof, and in which is shown by way of illustration the specific embodiment in which the invention may be practiced. It is to be understood that other embodiments may be utilized, as structural and operational changes may be made without departing from the scope of the present invention.

Generally, the present invention provides a system and method for facilitating downloading digital content, configuration data, or other data to devices otherwise limited in their ability to control the downloading of such data. A wireless device capable of communicating with the limited device, and also capable of wirelessly communicating, i.e., over-the-air (OTA), via a mobile communications network such as a cellular network, is used to control the data download on behalf of the limited device.

A wide variety of electronic devices are available on the market that operate under at least partial control of software, are configurable by software, utilize digital content, etc. In many cases, it would be desirable to be able to update content or other software in such devices. For example, new sounds or other software could be downloaded to electronic devices such as toys, doorbells, alarm clocks, and a wide variety of other consumer electronic devices. However, for various reasons it is generally not practical or economical to include the necessary user interface to such devices in order to initiate and control such data downloads. For example, keypads and other user entry mechanisms, display screens, may adversely affect the appearance, usability, or durability of the device. As a more particular example, consider a child's toy such as a stuffed animal that includes hardware and software allowing the toy to produce sounds, words, songs, etc. Inclusion of a keypad, display screen, etc. would significantly reduce the appeal of the toy. Furthermore, the addition of such interface mechanisms would increase the cost of the toy, potentially affecting its marketability. The available space on a particular electronic device may also make inclusion of user interface mechanisms an impossibility. Devices such as these are therefore “limited” in the sense that they do not, and/or can not, include the appropriate user interface mechanisms to initiate and control the download of content or other software.

The present invention addresses this problem by utilizing a mobile, wireless device to initiate, coordinate, or otherwise control the download of data to these limited devices, or even to other devices that are equipped with some type of user interface. Examples of a mobile device that may be used to control the download of data to a “target” device in accordance with the present invention include, for example, a mobile telephone, Personal Digital Assistant (PDA), wireless hand-held computer, or other wireless handset terminal including a user interface capable of initiating and controlling the data download. The present invention may be used with existing or future mobile devices having at least one secondary data transfer technology, such as a short-range data transfer capability, in addition to the ability to communicate with a network such as via cellular network technologies.

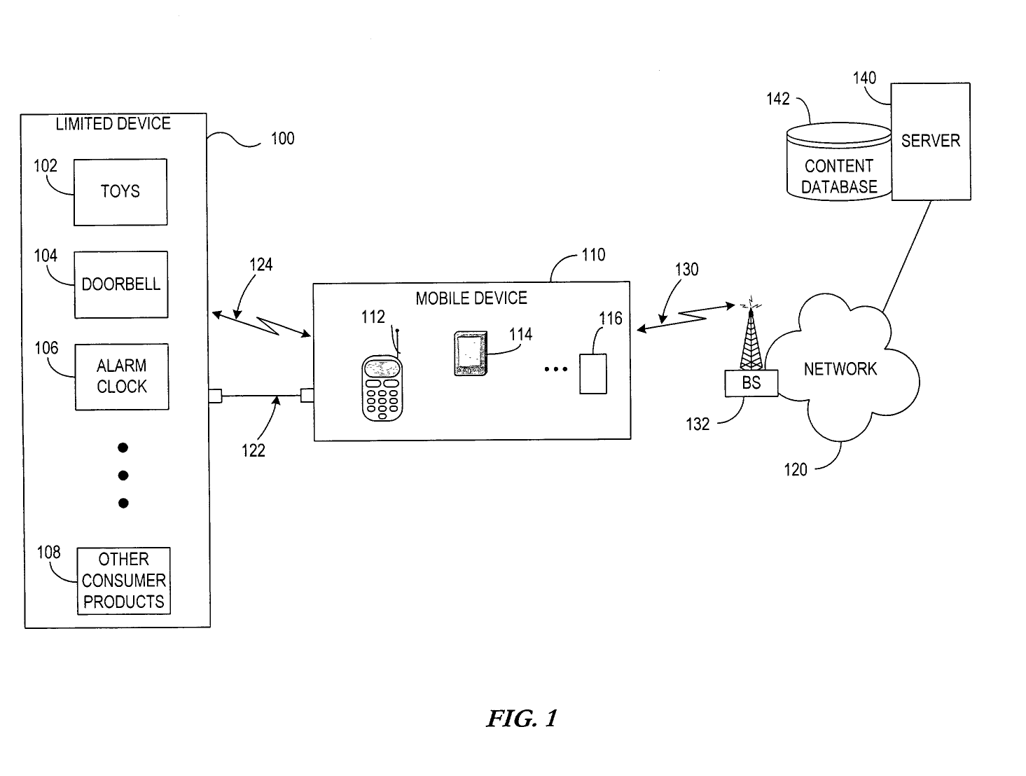

FIG. 1 is a block diagram illustrating one embodiment of the present invention. The limited device 100 represents a device having limited or no user interface capabilities that would allow it to initiate and effect a data download by itself. In the example of FIG. 1, a number of representative limited devices are illustrated, including toys 102, an electronic doorbell 104, an alarm clock 106, or other programmable or content-utilizing device represented by block 108. Where it is desired to download content or other software to the limited device 100, a mobile device 110 is utilized. The mobile device 110 represents a mobile device that can connect to the network 120, such as a mobile telephone 112, Personal Digital Assistant (PDA) 114, or other wireless device 116. As will be described in greater detail below, the mobile device 110 is essentially used as a modem by the limited device 100. A data transfer technology, such as infrared data transmission, is used to communicate information between the limited device 100 and the mobile device 110. In this manner, data download size is limited only by the time the user is willing to spend on the mobile device 110 call.

While the mobile device 110 may be used as a modem via a data transfer technology common to both the mobile device 110 and the limited device 100, the limited device 100 may need the phone number (or other destination identifier) to which the data call should be placed. In accordance with one embodiment of the invention, a phone number (or other destination identifier) to which the data call is to be directed is provided by the mobile device 110 to the limited device 100. Other information may also be provided to the limited device 100, such as a transaction identifier (ID) that allows access to the transaction information, such as an identifier corresponding to the content or other digital data to download. The limited device 100 may then use that information when making the data call. In accordance with one embodiment of the invention, the phone number, transaction identifier, or other information is transmitted via Short Messaging Service (SMS).

An embodiment of the invention is now described where it is assumed that the mobile device 110 already possesses the phone number and transaction identifier. In this example, a signal from a toy 102 is generated which will start a connection to a mobile phone 112. A user of the toy 102 may press a button, activate a switch, speak a voice command, activate a pressure transducer, activate a motion sensor, or perform another suitable act to activate the download functionality in the toy 102. Alternatively, the download functionality may be activated when the toy 102 detects that access to a mobile phone 112 is possible. For example, the toy 102 can detect an infrared signal of the mobile phone 112 when the phone's 112 infrared has been activated. Similarly, if a cable were to be used, the toy 102 could detect that a cable has been plugged in.

The toy 102 establishes contact with the mobile phone 112. While this contact may be performed using a cable connection 122 (e.g., serial, parallel, USB, Ethernet, etc.), a particularly beneficial implementation is via a wireless transmission 124, such as an infrared link, Bluetooth, etc. Upon establishing contact with the mobile phone 112, the toy 102 retrieves the phone number, transaction identifier, etc. that is stored in the mobile phone 112. Assuming, for example, that the mobile phone 112 obtained the phone number and transaction information via one or more SMS messages, the toy 102 retrieves the SMS message(s) stored in the mobile phone 112. In one embodiment, this is accomplished using AT (modem) commands over the infrared link 124. The toy recognizes the appropriate entry based on, for example, a character string such as “##TOY_DOWNLOAD,” and then extracts other information from the SMS message(s) such as the data size, transaction ID, phone number, etc. from the entry.

Using this information, the toy 102 initiates a data call to the extracted phone number by way of the mobile phone 112 via the infrared link. In one embodiment, the toy 102 sends a request where it specifies the make, model, etc. of the toy 102, the type of data it is able to handle (e.g., the type of audio data where audio content is sought), and the transaction ID. The mobile phone 112 receives this information via the infrared link 124, and appropriately demodulates the information for subsequent modulation and retransmission to the network 120 via radio link 130. For example, in a cellular network, the radio signal 130 from the mobile phone 112 is received at a base station (BS) 132, and subsequently transmitted through one or more mobile and possibly landline networks 120 to a server 140. The network 120 represents any one or more mobile and/or landline networks. The server 140 retrieves session data from a database 142 based on the transaction ID. The session data includes, for example, the content that should be downloaded, such as a Uniform Resource Locator (URL). Based on the information particular to the toy 102, the server 140 chooses a suitable version of the data (e.g., WAV, MP3, etc. in the case of audio data), and the data is downloaded to the toy 102 via the mobile phone 112.

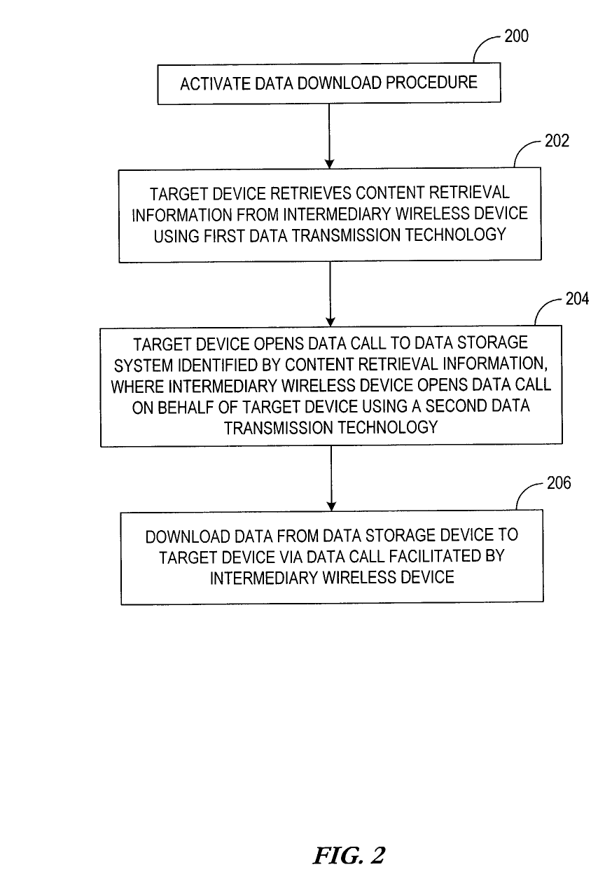

FIG. 2 is a flow diagram of one embodiment of a method for providing data to a target device. For purposes of illustration, this embodiment again assumes that the mobile device (e.g., mobile phone or other mobile communicator) has obtained the content retrieval information such as the data length, transaction identifier, phone number, etc. The data download procedure is activated 200. This may be accomplished by the user pressing a button on the target device, stating a voice command, or other interface mechanism. Alternatively, the procedure may be triggered by an event, such as a predetermined date/time, but the mobile device serving as an intermediary to the data download should be available at such a time. In order for the intermediary wireless device (e.g., mobile device such as a mobile phone) to recognize that the data download procedure has been activated, the mobile device may need to be located and/or positioned appropriately, depending on the data transfer technology employed between the mobile device and the target device. For example, if the data transfer technology is Bluetooth technology or Wireless Local Area Network (WLAN) technology, the mobile device would simply need to be within the appropriate transmission range. In one embodiment of the invention, infrared technology is utilized, and therefore the user turns on the infrared feature on the mobile device, and places it so there is a line-of-sight path of the appropriate distance between the mobile device and the target device.

When the mobile device has been located and/or positioned to communicate with the target device, and when the data download procedure has been activated 200 and contact has been made between the devices, the target device retrieves 202 the content retrieval information stored in the mobile device using a first data transmission technology. In one embodiment of the invention, this is accomplished using AT (modem) commands over an infrared link, although other communication protocols may be used. Upon receipt of the content retrieval information, the target device opens a data call to the data storage system that is identified by at least some of the content retrieval information, as shown at block 204. The mobile device opens the data call on behalf of the target device using a second data transmission technology, such as that used in networks including Global System for Mobile Communications (GSM), Universal Mobile Telecommunications System (UMTS), Personal Communications Service (PCS), Time Division Multiple Access (TDMA), Code Division Multiple Access (CDMA), or other mobile network transmission technology. In one embodiment, the data storage system is coupled to a network, which includes at least a mobile communications network to which the mobile device may wirelessly connect. The target device initiates the data call by utilizing at least some of the content retrieval information to facilitate connecting the data call, such as the phone number addressing the data storage system. By way of this data call facilitated by the intermediary mobile device, the data may be downloaded 206 from the data storage device to the target device. In one embodiment, data downloading to the target device is responsive to a request submitted by the target device to the data storage system (via the mobile device) once the data call has been appropriately set up.

As can be seen from the foregoing description, the present invention provides a number of advantages. For example, no user interface for seeking content retrieval information or controlling the data download is required in the target device, which allows download capabilities economical for the target device. Existing mobile devices having data transfer capabilities such as infrared capabilities may be used, without the need to introduce new technologies.

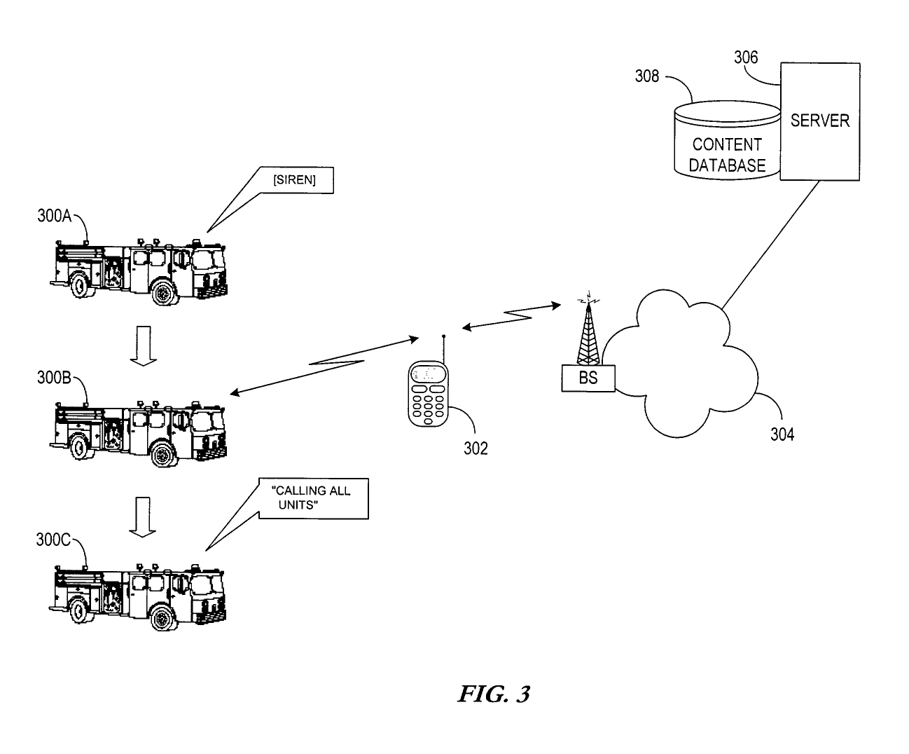

FIG. 3 is a block diagram illustrating a more particular example of the data downloading system and methodology of the present invention. In this embodiment, the target device is a toy such as a child's toy fire engine, and the intermediary wireless device is a mobile phone. Initially, the toy 300A may have one or more available audible sounds, such as one or more siren sounds. A user may become privy to new or updated sounds that are operable on the toy 300A. The user may discover the availability of such new/updated sounds through television, Internet, publications, or other advertisements by the toy manufacturer and/or one or more content providers, as well as through word-of-mouth, etc. The advertisement or other information may provide a contact number (e.g., a phone number) identifying where the content may be obtained. In accordance with one embodiment of the invention, a Short Message Service (SMS) message(s) is used to request the content from the appropriate content provider. In such case, the advertisement may also include a description of the syntax of the SMS message that the user should use. The SMS message is sent by the user from the mobile phone 302 via the network 304 to a premium SMS number identified in the advertisement which handles charging operations.

The content provider represented by the server 306 processes the SMS message and sends as a reply an SMS message that contains content retrieval information, such as data length, transaction ID, and phone number. The server 306 may store all session data, including at least an identifier for the desired sound clip, in the database 308 with the transaction ID as the key. The SMS message may also include further session information, such as the ID of the sound, or authentication information. This is not necessary, however, as the server 306 can store these and access them based on the transaction ID.

When the mobile device has received the reply SMS message from the server 306, the user can turn on the local data transmission technology that will be employed to communicate with the toy 300B. In one embodiment of the invention, this includes an infrared data transmission technology, and thus the user turns on the infrared feature on the mobile phone 302. In the case of infrared, the user places the mobile phone 302 so that there is a direct line-of-sight path between the infrared ports of the mobile phone 302 and the toy 300B. The user then activates the download functionality in the toy 300B, such as by pressing a button available on the toy 300B. The toy 300B establishes contact with the mobile phone 302 via infrared communication. The toy 300B then retrieves the SMS message(s) stored in the mobile phone 302 using, for example, AT (modem) commands over the infrared link. The toy 300B recognizes the correct entry, and extracts, for example, the data size, transaction ID, and phone number from the entry. The toy 300B may provide an audio signal to notify success. Further, if the toy 300B fails to have enough memory available to download the requested sound based on the retrieved content data size, another audio signal can be provided to notify the user of this failure condition.

The toy 300B then makes the data call to the extracted phone number, by way of the infrared link with the mobile phone 302 which in turn can communicate with systems coupled to the network 304. In the present example, the network 304 is a cellular network to which the mobile phone 302 can connect. For example, in a GSM network environment, the mobile phone 302 sees that the toy 300B is initiating a data call via the infrared link, and in turn the mobile phone 302 establishes the data call via the GSM network 304. The toy 300B then sends a request where it may specify its own make and model or other information characteristic of the toy 300B. Also provided with the request may be the type of audio data the toy 300B is able to accept, and the transaction ID. The server 306 retrieves session data from the database 308 based on the identifier, where the session data identifies the content that should be downloaded. Based on the information characteristic of the toy 300B, the server 306 chooses a suitable version of the requested audio data. The toy 300B may also attach its serial number or other unique identifier to the request, so that the server can enforce digital rights management by encoding the sound so that it can only be played by the toy 300B with that specific serial number/unique identifier.

At this point, the requested audio data is downloaded to the toy 300B by way of the mobile phone 302, which essentially operates as a modem between the toy 300B and the server 306. Upon completion of the download, the toy 300C may provide an audio signal to indicate successful download completion. When the download is complete, the toy 300C can operate with the new downloaded sound.

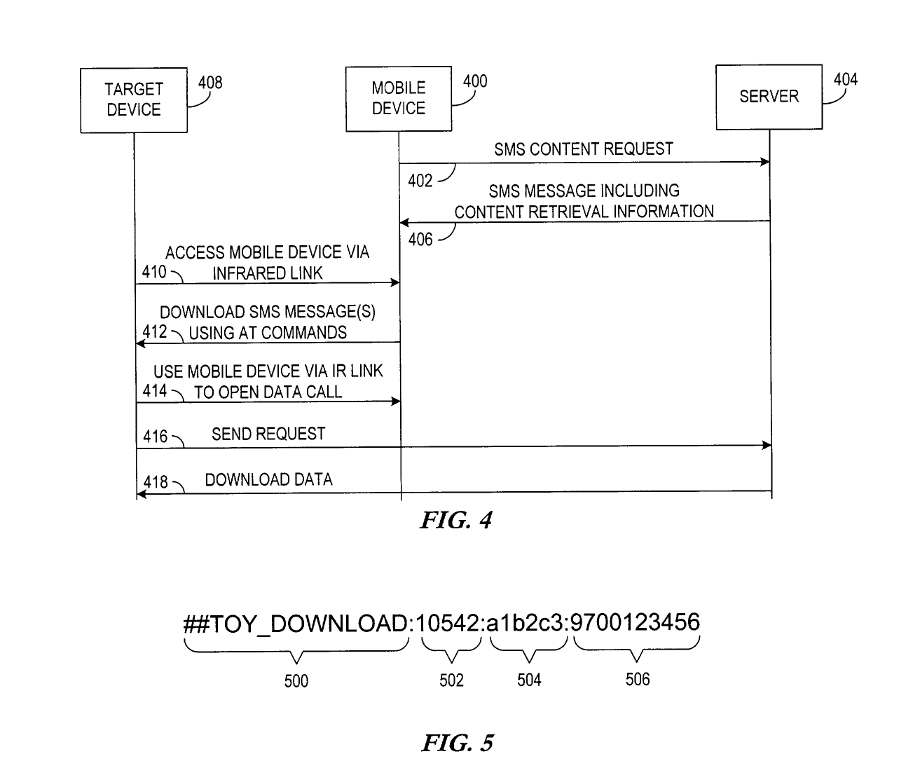

FIG. 4 illustrates a representative messaging sequence for downloading data to a limited device in accordance with one embodiment of the present invention. The user, via the mobile device 400, sends an SMS request shown on line 402 to the content provider, represented by the server 404. The request is sent to an address, such as a phone number, known to the mobile device 400 user. An example of an SMS request that may be used is as follows: “SOUND CALLINGUNITS,” where “SOUND” indicates the type of content desired, and “CALLINGUNITS” indicates the particular sound desired. The SMS request is sent to a premium SMS number, which takes care of charging.

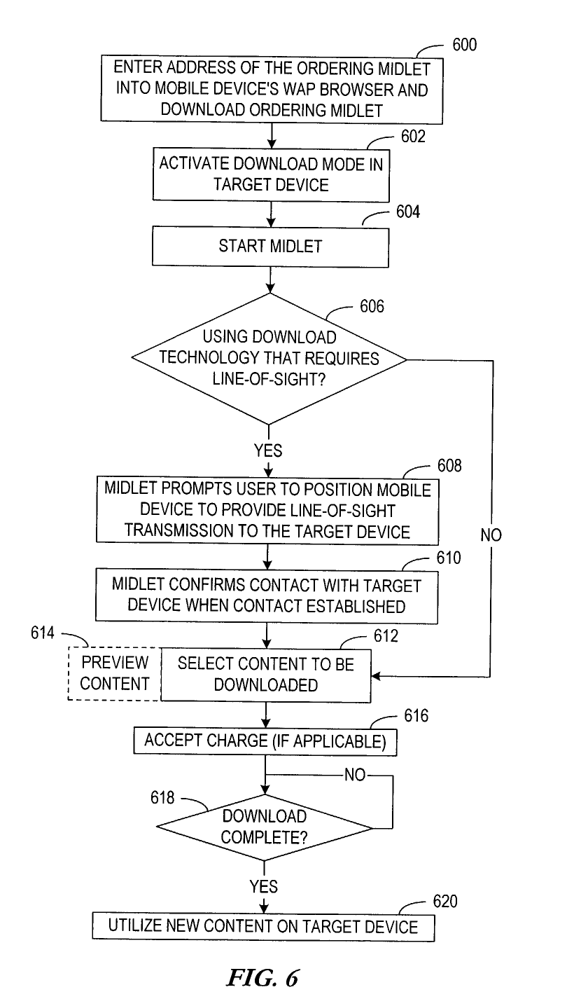

The server 404 processes the SMS request, and sends an SMS reply message as shown on line 406. The SMS reply message includes content retrieval information, such as the data length of the requested content, a transaction ID, and a phone number. The SMS reply message may be provided as shown in FIG. 5, where the SMS reply message may include a download entry name 500 (##TOY_DOWNLOAD), a data size 502 (10542 bytes), a transaction ID 504 (a1b2c3), and a phone number 506 (9700123456). The example of FIG. 5 is provided merely as an example of a reply message, as a variety of message types and formats may be used in connection with the present invention. Referring again to FIG. 4, the server 404 stores all session data, including at least an identifier for the sound clip, e.g., (http://sounds.com/callingunits/) in the database with the transaction ID as the key. The SMS may also optionally contain further session information, such as the ID of the sound, or authentication information.

When the mobile device 400 has received the SMS reply message, the user turns on the infrared communication feature on the mobile device 400, and positions it to communicate with the target device 408, which in this example is assumed to be a toy. The user activates the download functionality in the target device 408, and the target device 408 then accesses the mobile device 400 as represented by line 410. In response, the target device 408 receives the SMS message(s) stored in the mobile device 400 that were earlier received by the mobile device 400. More particularly, the target device 408 downloads the SMS message(s) using, for example, AT commands as shown on line 412, where the SMS message(s) corresponds to the SMS message(s) received at the mobile device 400 via line 406. The target device recognizes the correct entry based on the download entry name 500 (##TOY_DOWNLOAD), and extracts the data size 502 (10542 bytes), the transaction ID 504 (a1b2c3), and the phone number 506 (9700123456) from the entry.

At this point, the target device 408 uses the mobile device 400 via an infrared link to open a data call, as represented by line 414. The target device 408 sends a request, shown on line 416, where it specifies its make and model or other unique characteristic of the device 408. The type of audio data and the transaction ID are also provided with the request in this example. The server 404 retrieves session data from a database based on the transaction ID. The session data identifies the content that should be downloaded, such as a URL (e.g., http://sounds.com/callingunits/). Based on the target device 408 information such as the make and model, the server 404 chooses a suitable version of the audio data (e.g., “http://sounds.com/callingunits/wav_sound.wav”). The target device 408 may also attach its serial number or other unique identifier to the request, so that the server can enforce digital rights management by encoding the sound so that it can only be played by the target device 408 with that specific serial number or unique identifier. The audio data is then downloaded to the target device 418 by way of the mobile device 400, as shown on line 418. The target device 408 may provide an audio, visual, or other indication signifying successful completion of the data download.

The SMS message(s) with the content retrieval information shown on line 406 may also include configuration information for the data call. Because the number where the order SMS message(s) (line 402) is sent is likely operator-specific, the SMS reply message(s) (line 406) may include operator-specific settings for the data call. This may be particularly useful is Wireless Application Protocol (WAP) is used as the transport protocol, an example of which is described more fully below.

It is also noted that in some cases, it may be useful for the target device to present content at certain times. For example, it may be useful for a toy to play sounds at certain times. This requires the toy to keep track of the time, in order to play the sound at the desired time(s). While a microcontroller within the toy is capable of maintaining the time, the toy first needs to be set to the correct time. This can be accomplished, for example, during the data call. The server can include the current time in its response (line 418) to the download request (line 416). If the data calls are handled by a centralized server that serves several time zones, the server that handles the order SMS (line 402) can mark in the transaction data the time zone in which the customer resides.

It should also be noted, and will be readily apparent to those skilled in the art from the description provided herein, that other manners of communicating between the target device 408 and the mobile device 400 may be used instead of infrared as set forth above. For example, the target device 408 and the mobile device 400 may communicate using a cable, or via Bluetooth, or other existing or future communication technique.

As described above, the mobile device may communicate with the server or other content provider via SMS to provide the content request and obtain the content retrieval information. However, other methods may be employed. For example, business card SMS or “smart messaging” may be used. However, smart messaging is a proprietary technology, and may have a narrower compatibility as not all mobile phones implement the AT commands for the business card solution. Further, rather than the limited device “reading” the SMS from the phone using AT commands over infrared (e.g., message 412 of FIG. 4), the user can alternatively “send” the SMS via infrared to the limited device. Some mobile phones or other mobile devices provide a “print” option that allows an SMS to be “sent” from the mobile device over infrared. Another alternative is Multimedia Messaging Service (MMS). MMS messages are not limited in length, although individual mobile devices may limit length. MMS messages can be used to transfer content such as sounds without the need for a data call. However, in the MMS case, the serial number or other unique identifier of the limited device needs to be entered into the content request sent by the user to the server, since there is no direct communication between the limited device and the sound server.

Another download method that may be used in connection with the present invention includes downloadable code, such as, for example, a Java implementation. When mobile phones with Java become more prevalent, and Java “Mobile Information Device Applets” (midlets) can access a phone's infrared or Bluetooth functionality, the download functionality may be implemented as a Java midlet. This enables a user-friendly user interface. However, it may take years before the penetration of Java-capable mobile phones that also have an infrared or Bluetooth (or other) Java Application Programming Interface (API) are sufficient. In such an embodiment, the midlet is first downloaded from somewhere, such as the WAP pages of the sound download service. Once downloaded, the midlet can be stored on the mobile device so that it is immediately available the next time a download is desired. The midlet will open a local connection to the limited device using a technology such as Bluetooth or infrared, and will concurrently open a cellular connection to the content server. The midlet will then retrieve a list of available content items from the content server and display them to the user via the mobile device. After selecting a content item (e.g., a sound clip), the midlet can effect charging such as by sending an SMS or accessing a premium URL, and can then download the content and immediately forward it to the limited device.

The present invention is equally applicable to other downloadable code types other than the Java implementation described above. Any form of downloadable code may be used, and the Java description provided above is described for purposes of illustration, and not of limitation. For example, if a mobile device supports downloadable code other than Java, then that can be used as well. Such an application is downloaded and installed, and used similarly as in the midlet embodiment described above. As another particular example, Symbian™ Operating System (OS)-based mobile devices, such as the Nokia® 7650, allows new native code software to be downloaded and installed to the phone. As is known in the art, the Symbian™ OS is an open standard operating system for data enabled mobile phones.

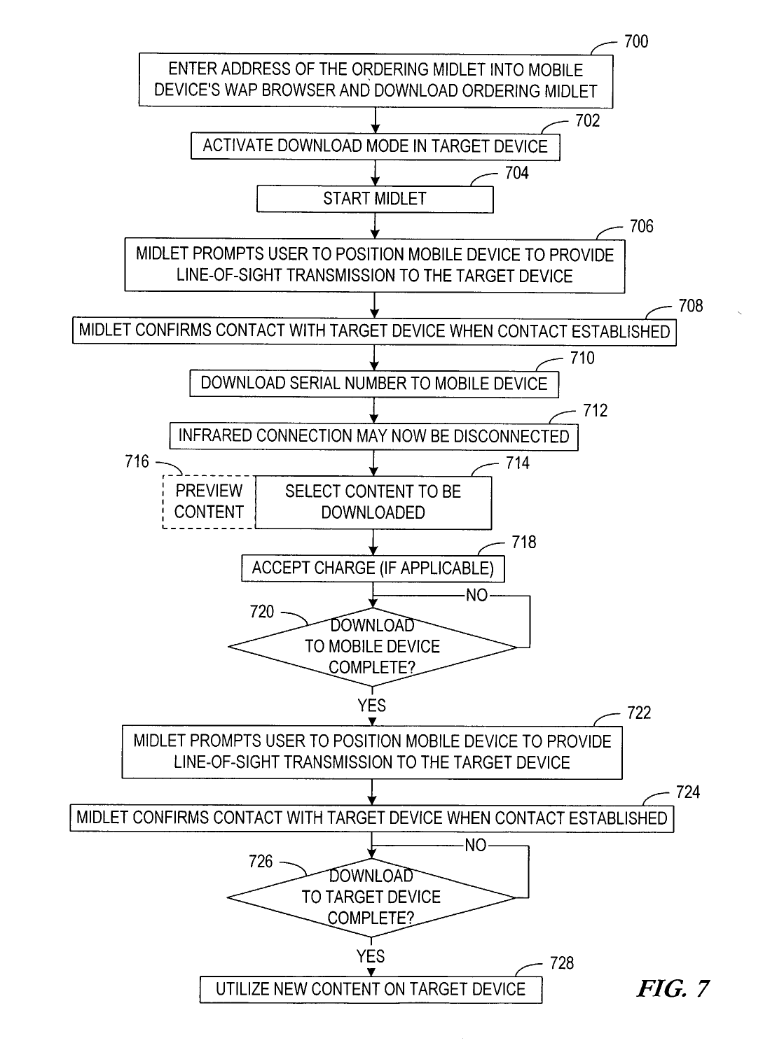

FIG. 6 is a flow diagram illustrating an exemplary download procedure utilizing a Java midlet from the user's point of view. The Java implementation described in connection with FIG. 6 is also applicable to embodiments utilizing download of other code types other than Java. The embodiment of FIG. 6 is therefore provided as a representative example. In the illustrated embodiment, the address (e.g., URL) of the ordering midlet is entered 600 into the mobile device's browser, such as a WAP browser, and the ordering midlet is downloaded to the mobile device. Downloading of the ordering midlet is only required once, as it can then be saved on the mobile device for future orders. The download mode in the target device is activated 602. This can be accomplished by pressing a button or other interface mechanism. The target device may provide an audio and/or visual indication that it is ready. The midlet is started 604 on the mobile device. If the download technology being used requires line-of-sight (e.g., infrared communication) as determined at block 606, the midlet prompts 608 the user to position the mobile device such that a line-of-sight transmission to the target device can be accomplished. In one embodiment, the midlet confirms 610 contact with the target device when contact has been established.

The user can then select 612 the content to be downloaded. For example, a number of different sound options may be presented to the mobile device user from which the user can make a selection. In one embodiment, the user may first preview the content to assist in the selection decision, as shown at block 614. For content requiring payment, the midlet may present the user with an option to accept the charge as shown at block 616. Assuming the charge was accepted, downloading of the selected content from the content provider to the target device via the mobile device begins, and continues until the download is complete as determined at decision block 618. When complete, the new content may then be utilized 620 on the target device. For example, where the target device is a toy, a button may be pressed on the toy to cause a newly downloaded sound to be presented.

In an alternative embodiment utilizing midlets (or analogous programs), the content itself may first be downloaded and stored to the mobile device, and sent to the target device when all of the data is available on the mobile device. If infrared is used for the target device-mobile device connection, this embodiment has the benefit that the infrared connection can be maintained for a shorter time period (assuming the infrared link transmits faster than the cellular data connection). However, the mobile device may still require the serial number or other unique identifier of the target device, in which case the serial number must be provided to the mobile device prior to the data download. This can be accomplished by providing the serial number to the mobile device via infrared, Bluetooth, etc., but this infrared/Bluetooth connection to provide the target device serial number may be performed at any time, and need not be performed in sequence with the data download. Alternatively, the user can also enter the serial number by hand to the mobile device. Providing the serial number to the mobile device prior to performing download procedures may be beneficial for other reasons, such as by allowing only those sounds that are compatible with the particular target device to be presented for selection.

An implementation such as that described in connection with FIG. 6 allows the same software (e.g., ordering midlet), which is downloaded by the user, to manage both the downloading of the data to the mobile device and the forwarding of the data to the target device. The software also retrieves information from the target device, such as the serial number and the data formats that the target device recognizes, and transmits that information to the server. The software allows the user to select from several alternatives for the data, and presents the user with an option to purchase the selected data.

FIG. 7 is a flow diagram illustrating an exemplary download procedure utilizing the alternative Java midlet embodiment described above. For purposes of discussion, the example of FIG. 7 assumes the use of infrared technology to communicate between the target device and the mobile device. The address (e.g., URL) of the ordering midlet is entered 700 into the mobile device's WAP browser and the ordering midlet is downloaded to the mobile device. As in the previous midlet example, downloading of the ordering midlet is only required once, as it can then be saved on the mobile device for future orders. The download mode in the target device is activated 702, and the target device may provide an audio and/or visual indication that it is ready. The midlet is started 704 on the mobile device. The midlet prompts 706 the user to position the mobile device such that a line-of-sight transmission to the target device can be obtained to facilitate the infrared connection. In one embodiment, the midlet confirms 708 contact with the target device when contact has been established. When contact has been established, the serial number is downloaded 710 to the mobile device, and the infrared connection may be disconnected 712.

The user can then select 714 the content to be downloaded. For example, a number of different sound options may be presented to the mobile device user from which the user can make a selection. In one embodiment, the user may first preview the content to assist in the selection decision, as shown at block 716. For content requiring payment, the midlet may present the user with an option to accept the charge as shown at block 718. Assuming the charge was accepted, downloading of the selected content from the content provider to the mobile device begins, and continues until the download is complete as determined at decision block 720.

At a suitable time, the user can then download the content to the target device. The midlet prompts 722 the user to position the mobile device such that a line-of-sight transmission to the target device can be obtained to facilitate the infrared connection. In one embodiment, the midlet confirms 724 contact with the target device when contact has been established, and may also display a progress bar to indicate how the sound data transfer to the target device is proceeding. When the download from the mobile device to the target device is complete as determined at decision block 726, the new content may be utilized 728 on the target device.

In an alternative embodiment of a download procedure utilizing the Java midlet embodiment, the address of the data may be hardcoded into the program itself. This allows the user to select the data by selecting the particular program that is downloaded. In such an embodiment, multiple Java midlets or other data ordering programs may be downloaded to the mobile device. Each of the Java midlets that are downloaded include a data address. The user can then select one of the Java midlets via the mobile device, and when the midlet is executed, the desired data that is stored at the corresponding data address at the data storage system is downloaded to the target device by way of the mobile device.

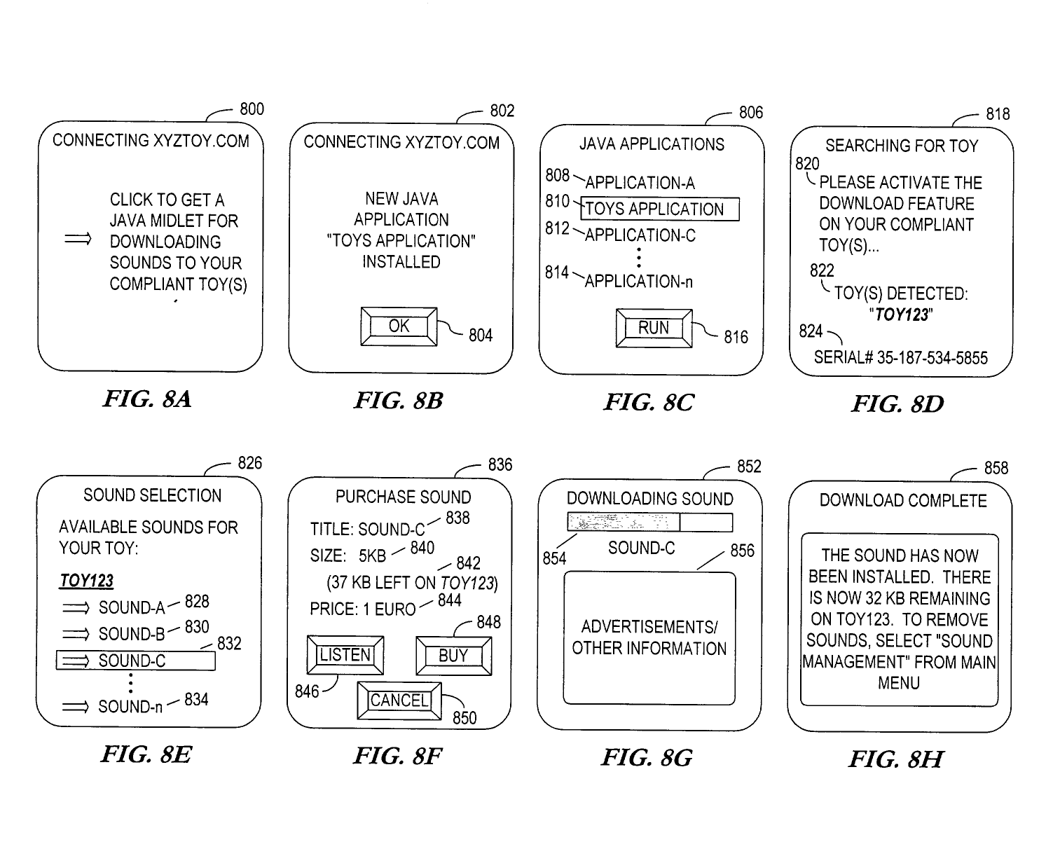

FIGS. 8A-8H illustrate a representative series of mobile device user interface screens that may be presented via the mobile device during a Java midlet download procedure. FIG. 8A presents a user interface screen 800, where the ordering Java midlet can be downloaded. When the order has been initiated, screen 802 of FIG. 8B is presented when the new application has been installed on the mobile device. Selecting the “OK” button 804 or other user interface mechanism may be used to return the user to a different screen or menu.

When desired, the user can view a list of applications available on the mobile device, an example of which is shown on screen 806 of FIG. 8C. In this example, a number of available applications are listed, including Application-A 808, Toys Application 810, Application-C 812, through Application-n 814. The user can select the appropriate application, which in the present example is the Toys Application 810, by highlighting the application 810 and selecting the “RUN” button 816. The user interface screen 818 shown in FIG. 8D includes a text message 820 prompting the user to activate the toy's (e.g., target device's) download functionality. The midlet can display some information 822 about the toy that is under consideration. This may be beneficial, as it is possible that multiple toys can be detected via the download procedure, particularly where the download technology is not line-of-sight such as the case with Bluetooth technology. In the illustrated embodiment, the serial number of the detected toy is obtained and displayed 824.

The mobile device presents a list of sounds available for the toy, as shown on screen 826 of FIG. 8E. In the illustrated embodiment, the toy serial number is known, which allows only those sounds that are compatible with the particular toy (TOY123) to be displayed. These sounds include Sound-A 828, Sound-B 830, Sound-C 832, through Sound-n 834. Information about the selected sound may be shown to the user, such as that illustrated via user interface screen 836 of FIG. 8F. The information illustrated in this example includes the title 838 of the selected sound, the size 840 of the sound clip, the remaining memory 842 on the particular toy, and the purchase price 844. The user may choose to preview the sound clip by selecting the “LISTEN” button 846, and/or purchase the sound clip by selecting the “BUY” button 848. In some cases, the content may be free, in which case the “BUY” selection option may simply download the content. The user may cancel the sound download by selecting the “CANCEL” button 850.

Assuming the user chose to purchase the sound, screen 852 shown in FIG. 8G is presented, and the sound is downloaded. During the download process, a progress bar 854 may be presented, as well as other information such as advertisements 856. Finally, a report of success may be presented as shown on screen 858 of FIG. 8H. The report may include information regarding sound management possibilities or other information. As will be readily apparent to those skilled in the art from the description provided above with respect to FIGS. 8A-8H, the embodiments described are merely representative of the type of user interface that may be presented in connection with a Java midlet implementation.

In accordance with the present invention, a number of different download transport protocols may be used. A first approach is to use data transfer protocols such as Kermit, xmodem, or zmodem over a raw data connection. The benefit of this approach is that the target device side is as simple as possible. The disadvantage is that the dial-in server receiving the data calls may require customization for this purpose. A second alternative is to use WAP. The target device would include a minimal WAP stack and use WAP protocols to download the data from a central web site. The operator's WAP gateway may have to be configured to allow access to the website. The benefit of this approach is that no special dial-in server is required, as the operator's standard WAP service is sufficient. However, this adds complexity to the target device, which translates to additional development time and cost, and possibly increased unit cost. Still another alternative is to use TCP-IP (Transmission Control Protocol/Internet Protocol) or HyperText Transfer Protocol (HTTP). The target device would therefore include a minimal IP stack. Any Internet Service Provider's (ISP) dial-in lines can be used to access the central web site and download the data. Advantages and disadvantages of this approach are similar to the WAP approach described above, with the added disadvantage that ISPs are generally not a free service—either the user would pay an additional cost in the call charges, or the download service could make a deal with the ISPs. Note that whichever method is used, the SMS with download information can contain operator-specific configuration information for the download transport protocol.

Selection of content can also be effected in a variety of manners. In a simplistic example, a content item such as a sound clip is selected by entering the correct keyword(s) in the SMS content request. This, however, has the drawback that the user has to know what keywords are available. As in the case of ringtones, such keywords may be discovered in advertisements in newspapers, magazines, or other advertisement media. Other possibilities also exist. For example, a WAP service may be provided where a user can select a sound using a WAP browser on the mobile device. If the mobile device supports audio WAP content, the user can even listen to a preview of the sound. Selecting a sound for download causes an SMS message with the download information to be sent to the user's mobile device (as with SMS content request). Charging may be performed via WAP charging mechanisms.

Another example of a manner of selecting sound is a service that utilizes the Internet, such as World Wide Web (WWW) pages. Similar to the WAP example above, when the user selects content such as a sound by browsing the web page(s) and selecting the appropriate user interface icon, such as a “buy” button provided via the web page(s). The operator's portal platform allows for charging for the content via the user's phone bill, and an SMS or other message with the download information is sent to the user's mobile device. Further, as previously described in connection with FIGS. 6, 7, and 8A-8H, Java midlets or other downloadable code technology can be used for browsing and ordering content where the user's mobile device supports Java or other downloadable code.

Charging for the downloaded data or content may also be accomplished in a number of ways. In the case where an SMS content request is sent from the mobile device to a content provider via the network, the SMS content request is sent to a premium SMS number which manages the charging function. Where an SMS message is not used to select content, other methods may alternatively be used. For example, if using WAP, premium WAP pages are a viable alternative. Known charging methodologies may be implemented in connection with the present invention.

Sound management may also be an issue. For purposes of this description, it will be assumed that the target device is a toy that produces sounds. If a particular toy supports more than one sound, the sound that is to be replaced by the new sound should be specified. One possibility in accordance with the present invention is for the user to include a content identifier corresponding to the sound to be replaced in the content request sent to the content provider. The content provider stores the content identifier in the session information, and the toy in turn receives the content identifier when downloading the new sound. The content identifier will notify the toy of which sound is to be replaced. In one particular example, the content identifier may correspond to the name of a button on the toy. In this case, there is exactly one sound per button. The SMS content request would then be, e.g. “SOUND CALLINGUNITS FIRE” (syntax: <download command> <sound name> <button name>). This would cause the “CALLINGUNITS” sound to be downloaded and played whenever the “FIRE” button is pressed on the toy. If the SMS content request does not specify a button, a default button could be used.

A more complex possibility is to associate several (numbered) sound slots with each button. The user specifies a slot when downloading a sound, and if the slot is already associated with a sound, that sound will be overwritten. In this case, the user keeps track of which sound corresponds to which slot. The toy could provide information of slot allocation, for example, by creating a report SMS on the mobile device following a successful content download. The SMS content request could therefore be “SOUND CALLINGUNITS FIRE 2”, where the numeral “2” indicates that the sound should be placed in slot #2 for the fire button. An example of a report SMS generated by the toy is “FIRE 1: LASER/FIRE 2: CALLINGUNITS”. Since there would now be multiple sounds associated with a single button, the sound to be played is selected each time the button is pressed. This can be accomplished randomly, by playing each sound in turn, etc.

Sounds might also be explicitly managed by creating an SMS message on the mobile device with some keyword such as “TOY_MANAGEMENT,” and sound management instructions such as “DELETE FIRE 1.” The mobile device infrared can then be activated, and the toy download function initiated. The toy would not find any SMS with download information, but would find the SMS message with the sound management information, and would act accordingly. After the management operation, the toy could create a report SMS as set forth above.

When Java and infrared/Bluetooth Java APIs are commonly available on mobile phones and other mobile devices, Java can be used to provide a convenient management interface for sounds. The Java user interface on the mobile device can present a list of content items stored on the toy, and allow them to be organized, deleted, etc.

Content may also be collected, and in some cases directly transferred or the rights to the content transferred. If the transaction record is stored on the server for a sufficient time, the user can keep the retrieved SMS message with the download information for a corresponding length of time before activating the download. The user may even transfer the retrieved SMS message to another user since anyone can use it. However, in one embodiment, only the first user to download the information will be able to obtain the content. A limitation may be that the sound may only be downloaded to a target device for which digital rights management allows the download, e.g., playing a particular sound on a particular toy is allowed by both the toy manufacturer and the sound creator. This makes it possible for the user to store many sound SMS messages on his or her mobile device. Since the user may now have several SMS messages with download information on his or her mobile device, the user needs the ability to select one of them. This can be accomplished, for example, by adding a specific letter (e.g. “P” or “Priority”) in the beginning of the stored SMS message with the download information.

Another feature is the ability to provide a purchased content item itself to another user. This is possible by sending an SMS message with the original transaction ID and the phone number of the receiving device. The service then allocates a new transaction ID, replaces the old transaction ID with the new transaction ID in the transaction record, and sends an SMS message with download information using the new transaction ID to the receiver. Since the new transaction ID is not disclosed to the sender, the receiver has now “ownership” of the download—the sender cannot use it anymore unless the receiver discloses the new transaction ID.

Another concept associated with the present invention is content recovery. For example, it would be useful to enable the user to again download a previously purchased sound at a nominal cost. This would prevent user dissatisfaction in case of accidental deletion of one or more sounds (or other content items). This may be implemented by maintaining the transaction information at the content server after a download is complete. When the user has downloaded a sound, the user can record the transaction ID. By sending the transaction ID at a later time with an SMS content request, the user is able to download the same sound again. In one embodiment, the sound will only work with the same target device to which it was originally downloaded, since the target device's serial number is recorded when the first download was completed. Alternatively, the service may send a “backup SMS” message to the user after a successful download that the user can either directly use to initiate a download, or send the backup SMS message to a service number to obtain a new SMS message with download information (at nominal cost).

It is possible that the user may lose SMS messages with download information, e.g., as the result of a mobile device “crash.” It may be advantageous to have an additional service allowing the user to obtain new SMS messages with download information for any incomplete transactions that have been purchased. Backup SMS messages as described above could also be used to again obtain content downloaded earlier but subsequently lost.

Since there are sounds or other content that cannot be played with all toys due to digital rights management protection, a user may inadvertently purchase content that cannot be used on the target device. A replacement service could be created which would allow a new sound, for example, to be selected by using an SMS content request which includes the transaction ID of the original SMS message retrieved by the target device. The service then invalidates the transaction ID (making it impossible to download the originally downloaded sound), and sends a new SMS message with download information for the replacement sound.

Digital Rights Management (DRM) in the context of the present invention is restricted in the sense that the processing resources available at the target device are often limited. Public key encryption is therefore not feasible in most cases, particularly in the case of relatively inexpensive toys and the like. However, block ciphers may be used. On the other hand, because the cost of a single download may be relatively small (e.g., $1, 1 Euro, etc.) the DRM methods used do not have to be flawless. They should be sufficiently hard to crack such that it is not worth the effort to do so. A current analogy is in the area of ringing tones, where DRM operates on a similar philosophy—ringing tones are easy to copy, but so inexpensive that it may not present a major concern. However, because the quality of the content provided in connection with the present invention may be substantially greater than that of ringing tones, the DRM provided in connection with the present invention should not be trivial.

There are a number of security threats to which DRM can address, including copying downloaded content, using the retrieved SMS message with the download information several times to make several downloads, downloading content to a device unauthorized by the content creator, and downloading unauthorized content (i.e., unauthorized by the device maker) to a device. In accordance with one embodiment of the invention, a twofold solution is presented. First, content may be encrypted prior to the download so that it can only be decrypted by a particular target device, and second, the received SMS message that includes the download information may be designated as a single-use ticket.

With respect to the first part of the solution, each target device includes a serial number and a secret code created in advance, such as at the factory. The mapping from serial number to secret code is stored when target devices are manufactured, and this mapping is made available to the (trusted) download server. When the target device requests content, it attaches its serial number to the request. The server indexes the corresponding secret code, and encrypts the content with the code. The target device may then decrypt the content using the resident secret code.

In another implementation, each target device has a randomly generated secret code. This, however, makes the mapping table from serial numbers to secret codes very large. A more space-efficient solution involves generating the secret codes from base codes that are specific to a target device type or manufacturer. For example, in the case where the target device is a toy, a serial number could take on a form such as 35-187-5345855, where “35” identifies the toy manufacturer, “187” identifies the toy type (e.g. brand name doll model) and “5345855” corresponds to a running number that identifies this particular toy. The secret code can now be generated by hashing the manufacturer or toy type-specific base code with the serial number. If a secure one-way hashing function is used, knowing the hash function and the serial number and secret code of a particular toy does not disclose the base code. The server can now look up the base code using the first part of the serial number, and generate the secret code using the base code and the serial number. The toy does not generate the secret code dynamically, but rather the code is generated and stored to the toy at manufacturing time. In this way, hacking a particular toy does not disclose the secret base code.

Further security can be provided by encrypting all communication over the data call between server and toy with the toy's secret code, and authenticating the toy and server. In this case, the toy first sends an authentication request containing its serial number, and a random number encrypted with the secret code. The server decrypts the number and returns the decrypted number, thus proving that it knows the secret code without disclosing the secret code. The server can authenticate the toy in a similar manner. Once authentication is complete, all communication can be encrypted with the secret code. This kind of authentication/encryption is well known, such as Bluetooth security protocols. Note that this kind of further security is not necessary, but can be used to make analysis of the toy-server protocol more difficult.

With respect to the second part of the solution, a simple electronic ticketing strategy may be used. For example, when a transaction has been paid (i.e., an SMS content request has been received), a session record is created. In one embodiment, a download can only be initiated when an active session record exists. The record is deleted (or at least made inactive) when a download is completed. In other words, the transaction is marked as “used.” Thus, one payment can result in at most one download. Of course, error situations complicate this somewhat, in that a download must not be considered complete before it is successful.

With such solutions, the previously mentioned security threats can be countered. Since content will only work with a single target device, copying the content is of no use. Marking the transaction as “used” prevents multiples uses of the received SMS that includes the download information. With respect to downloading content to an unauthorized device, content producers can create a list of authorized target devices and deliver it to the download service provider. The download server can match the toy type (available from the serial number) against the list of authorized target devices, and refuse the download if the target device is not authorized. Since the content can be decrypted only by the target device with the correct serial number, using a false serial number is useless. Finally, with respect to downloading unauthorized content to a device, this is solved similarly to the previous security threat where the content is downloaded to an unauthorized device. The difference being that there is a list of authorized content for a toy type, provided by the toy manufacturer.

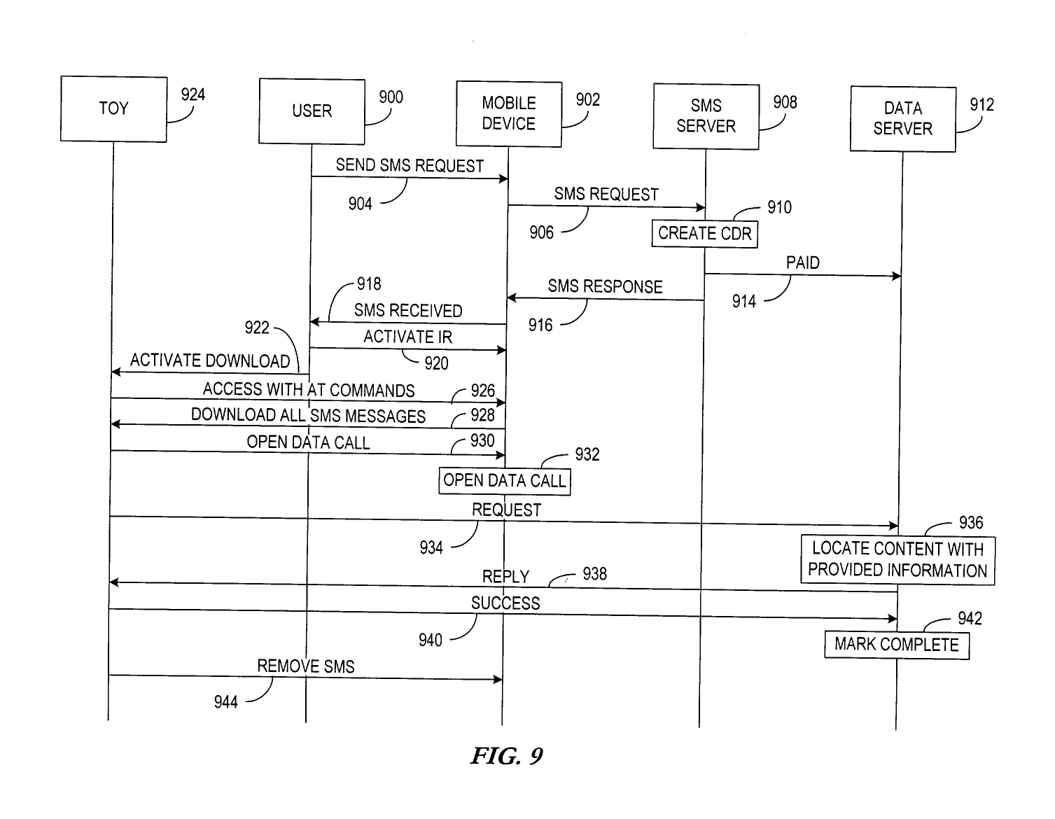

An example of a message sequence including content encryption and marking transactions is provided in FIG. 9. For purposes of this example, it is assumed that the target device is a toy that can present sounds, and the mobile device is a mobile phone operable on a mobile communications network. In the illustrated embodiment, the user 900 operates the mobile phone 902 to send an SMS request as depicted on line 904. The SMS message includes a sound ID and a toy button ID in this example. The SMS message is provided 906 via the mobile phone 902 to the SMS server 908. A charging record (CDR) is created 910, and the SMS server 908 notifies the data server 912 that payment has been made as depicted by line 914. Along with this notification 914, the transaction ID, sound ID, and button ID are provided to the data server 912. An SMS response including the transaction ID and phone number are provided by the SMS server 908 to the mobile phone 902 as shown on line 916, where the user 900 ultimately receives the SMS response as shown on line 918. The user activates 920 the infrared (IR) on the mobile phone 902, and also activates 922 the download feature on the toy 924. The toy 924 accesses 926 the SMS messages using AT commands, and the SMS messages (including the transaction ID and phone number) are downloaded to the toy 924 as shown on line 928. The toy 924 initiates opening of the data call as shown on line 930, and the mobile phone 902 opens 932 the call.

The toy 924 sends a content request via the mobile phone 902 to the data server 912 as shown on line 934. The request includes the transaction ID, the toy serial number, and the formats supported by the toy 924. The data server locates 936 the sound with the information provided. More particularly, the data server 912 looks up the previously stored sound ID and button ID using the transaction ID provided by the toy 924, and also looks up the encryption key using the serial number provided by the toy 924. The data server 912 then sends a reply 938 to the toy 924 via the mobile phone 902, and the toy 924 responds with a success notification 940 providing the transaction ID if properly received. The data server 912 marks the transaction as complete 942, and the SMS message is removed 944 from the toy 924.

Using the description provided herein, the invention may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the invention. As such, the terms “article of manufacture” and “computer program product” as used herein are intended to encompass a computer program that exists permanently or temporarily on any computer-usable medium or in any transmitting medium which transmits such a program..

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links.

From the description provided herein, those skilled in the art are readily able to combine software created as described with appropriate general purpose or special purpose computer hardware to create a mobile computer system and/or computer subcomponents embodying the invention, and to create a mobile computer system and/or computer subcomponents for carrying out the method of the invention.

The foregoing description of the exemplary embodiment of the invention has been presented for the purposes of illustration and description. It is not intended to be exhaustive or to limit the invention to the precise form disclosed. Many modifications and variations are possible in light of the above teaching. For example, it will be apparent to those skilled in the art from the foregoing description that the device to which data is downloaded need not have a limited user interface. The present invention is equally applicable to devices that are in and of themselves capable of carrying out the data download, but for one reason or another utilize the mobile device as described above. The present invention is also applicable to any type of downloaded data that might be of use to the limited device, such as sound, images, video, configuration data, program updates, etc. It is intended that the scope of the invention be limited not with this detailed description, but rather by the claims appended hereto.

What is claimed is:

1. A method for acquiring data retrieval information at a target device, comprising:
initiating, at the target device, a connection between the target device and a mobile device storing the data retrieval information; and
communicating the data retrieval information from the mobile device to the target device, wherein the data retrieval information is available for use by the target device in retrieving desired data identified by the data retrieval information.

2. The method of claim 1, wherein initiating a connection between the target device and the mobile device comprises detecting communication availability of the mobile device by the target device.

3. The method of claim 2, wherein detecting communication availability of the mobile device by the target device comprises detecting, by the target device, a wireless signal issued by the mobile device.

4. The method of claim 2, wherein detecting communication availability of the mobile device by the target device comprises detecting, by the target device, an infrared signal issued by the mobile device.

5. The method of claim 2, wherein detecting communication availability of the mobile device by the target device comprises detecting, by the target device, connection of a cable to the target device.

6. The method of claim 1, wherein initiating a connection between the target device and the mobile device comprises activating a user input mechanism on the target device by a user.

7. The method of claim 6, wherein activating a user input mechanism comprises any one or more of speaking a voice command, pressing a button, activating a switch, activating a pressure transducer, and activating a motion sensor.

8. The method of claim 1, wherein communicating the data retrieval information comprises downloading the data retrieval information via a wireless connection.

9. The method of claim 8, wherein downloading the data retrieval information via a wireless connection comprises downloading the data retrieval information from the mobile device to the target device via at least one of an infrared connection, a Bluetooth connection, and a Wireless Local Area Network (WLAN) connection.

10. The method of claim 1, wherein communicating the data retrieval information comprises downloading the data retrieval information via a wired connection.

11. The method of claim 1, wherein communicating the data retrieval information comprises downloading the data retrieval information via modem commands.

12. The method of claim 1, further comprising:
establishing a data call between the target device and the data storage system by way of the mobile device, wherein the data call is established using at least some of the data retrieval information; and
transmitting the desired data from the data storage system to the target device via the data call established by way of the mobile device.

13. The method of claim 12, wherein transmitting the desired data from the data storage system to the target device comprises:
transmitting the desired data from the data storage system to the mobile device using a first wireless technology; and
transmitting the desired data from the mobile device to the target device.

14. The method of claim 13, wherein transmitting the desired data from the data storage system to the mobile device using a first wireless technology comprises transmitting the desired data via a mobile communications network.

15. The method of claim 13, wherein transmitting the desired data from the mobile device to the target device comprises transmitting the desired data from the mobile device to the target device via a cable.

16. The method of claim 13, wherein transmitting the desired data from the mobile device to the target device comprises transmitting the desired data from the mobile device to the target device using a second wireless technology.

17. The method of claim 16, wherein transmitting the desired data from the mobile device to the target device via a second wireless technology comprises transmitting the desired data via at least one of an infrared connection, a Bluetooth connection, and a Wireless Local Area Network (WLAN) connection.

18. The method of claim 13, wherein transmitting the desired data from the data storage system to the target device comprises transmitting the desired data from the data storage system to the target device using a data transfer protocol including at least one of Kermit, xmodem, zmodem, Wireless Application Protocol (WAP), and Transmission Control Protocol/Internet Protocol (TCP/IP), and HyperText Transfer Protocol (HTTP).

19. The method of claim 12, further comprising transmitting a data request signal from the target device to the data storage device via the data call established by way of the mobile device, and transmitting the desired data from the data storage system in response to the data request signal.

20. The method of claim 12, wherein the data retrieval information includes at least a communication address of the data storage device, and wherein the data call is established using at least the communication address of the data storage device.

21. The method of claim 12, wherein the data retrieval information further comprises configuration information for establishing the data call.

22. The method of claim 12, further comprising a step for encrypting the desired data prior to transmitting the desired data from the data storage system.

23. The method of claim 12, further comprising encrypting the desired data prior to transmitting the desired data from the data storage system, wherein encrypting comprises locating a secret code stored at the data storage system using a unique identifier of the target device provided by the target device during the data call, and encrypting the desired data using the secret code.

24. The method of claim 12, further comprising designating a message that includes the data retrieval information as a single-use ticket.

25. The method of claim 12, wherein the target device performs at least one operation based on a current time and the current time is provided to the target device via the data call, and further comprising:
extracting, at the target device, the current time from accompanying data provided with the desired data; and
setting a current time value stored within the target device to the current time obtained from the accompanying data.

26. The method of claim 1, further comprising communicating the data retrieval information from a data storage system storing the desired data to the mobile device prior to communicating the data retrieval information from the mobile device to the target device.

27. The method of claim 26, wherein communicating the data retrieval information to the mobile device from the data storage system comprises transmitting at least one wireless message including the data retrieval information from the data storage system to the mobile device.

28. The method of claim 27, further comprising initiating a request for the data retrieval information from the mobile device to the data storage system via a wireless request message, wherein the wireless message from the data storage system is transmitted to the mobile device in response to the wireless request message.

29. The method of claim 27, wherein transmitting at least one wireless message from the data storage system to the mobile device comprises transmitting at least one message via at least one of a smart message, an SMS print message, an Enhanced Messaging Service (EMS) message, and a Multimedia Messaging Service (MMS) message.

30. The method of claim 26, wherein communicating the data retrieval information to the mobile device from the data storage system comprises transmitting at least one Short Message Service (SMS) message including the data retrieval information from the data storage system to the mobile device.

31. The method of claim 30, further comprising initiating a request for the data retrieval information from the mobile device to the data storage system via an SMS request message, wherein the SMS message from the data storage system is transmitted to the mobile device in response to the SMS request message.

32. The method of claim 31, wherein initiating a request for the data retrieval information from the mobile device to the data storage system comprises transmitting the SMS request message to a premium SMS number where charging functions for retrieving the desired data are managed.

33. The method of claim 1, wherein the desired data comprises any one or more of digital content, target device configuration data, and software operable on the target device.

34. A method for downloading desired data to a target device, comprising:
downloading over-the-air (OTA) a data ordering program to an intermediary mobile device;
executing the data ordering program on the intermediary mobile device;
selecting, via the data ordering program on the intermediary mobile device, desired data to be downloaded from a data storage system to the target device; and
downloading the selected data from the data storage system to the target device by way of the intermediary mobile device.

35. The method of claim 34, wherein downloading the selected data from the data storage system to the target device comprises downloading the selected data via a wireless communication technology from the data storage system to the intermediary wireless device, and downloading the selected data from the intermediary wireless device to the target device via a cable.

36. The method of claim 34, wherein downloading the selected data from the data storage system to the target device comprises downloading the selected data via a first wireless communication technology from the data storage system to the intermediary wireless device, and downloading the selected data from the intermediary wireless device to the target device via a second wireless communication technology.

37. The method of claim 36, wherein the second wireless communication technology comprises at least one of an infrared connection, a Bluetooth connection, and a Wireless Local Area Network (WLAN) connection.

38. The method of claim 34, wherein downloading OTA a data ordering program comprises downloading a Java midlet to a Java-compliant intermediary mobile device.

39. The method of claim 34, wherein downloading OTA a data ordering program comprises downloading the data ordering program to a Symbian OS-based intermediary mobile device.

40. The method of claim 34, wherein downloading the selected data comprises downloading the selected data from the data storage system to the intermediary mobile device at a first time, and downloading the selected data from the intermediary mobile device to the target device at a subsequent time.

41. The method of claim 34, wherein downloading the selected data comprises downloading the selected data from the data storage system to the intermediary mobile device substantially concurrently with downloading the selected data from the intermediary mobile device to the target device.

42. The method of claim 34, further comprising presenting a user of the intermediary mobile device with an option to purchase the selected data prior to downloading the selected data to the target device.

43. A method for downloading desired data to a target device, comprising:
downloading over-the-air (OTA) one or more data ordering programs to an intermediary mobile device, wherein each the data ordering programs includes a data address;
executing one of the data ordering programs on the intermediary mobile device; and
in response to executing one of the data ordering programs, downloading the desired data stored at the data address of a data storage system to the target device by way of the intermediary mobile device.

44. A system for distributing digital data, comprising:
a data storage system to store available digital data;
a target device capable of communicating through a local connection; and
an intermediary wireless device configured to communicate over-the-air (OTA) remotely with the data storage system, wherein the intermediary wireless device is further configured to control retrieval and/or order information for digital data download from the data storage system to the target device via the intermediary wireless device.

45. The method of claim 44, wherein the target device is capable of initiating a digital data download through the local connection.

46. The method of claim 44, wherein the intermediary wireless device is configured to download OTA a data ordering program for downloading data to the target device.

47. The method of claim 44, wherein the target device comprises a user interface to initiate the download of the digital data from the data storage system via the intermediary wireless device.

48. The method of claim 44, wherein the intermediary wireless device comprises a user interface to facilitate control of the download of the digital data from the storage system to the target device.

49. The method of claim 44, wherein the intermediary wireless device comprises an interactive program to facilitate selection of the digital data, and control of the download of the digital data from the storage system to the target device.

50. The method of claim 44, wherein the intermediary wireless device comprises a wireless handset terminal, including at least one of a wireless telephone, a Personal Digital Assistant (PDA), a hand-held computer, and a mobile communicator capable of communicating over a mobile communications network.

51. The method of claim 44, wherein the intermediary wireless device and the target device each comprise a wireless interface to communicate OTA therebetween, wherein a wireless technology used to communicate between the intermediary wireless device and the target device is different from the wireless technology used to communicate between the intermediary wireless device and the data storage system.

52. The method of claim 51, wherein the mobile communications network comprises one of a Global System for Mobile Communications (GSM) network, UMTS network, Time Division Multiple Access (TDMA) network, Code Division Multiple Access (CDMA) network, and Personal Communications Service (PCS) network.
